(19) United States
(12) Patent Application Publication
(10) Pub. No.: US 2002/0131422 A1
(43) Pub. Date: Sep. 19, 2002

(54) Method of allocating resources for network capacity management of voice traffic in a packet based broadband access network

(76) Inventors: Thomas P. Chu, Englishtown, NJ (US); Jiong Gong, Berkeley Heights, NJ (US)

Correspondence Address: Thomas P. Chu, 31 Highland Drive, Englishtown, NJ, 07726, US

(21) Appl. No.: 09/804,121

(22) Filed: Mar. 13, 2001

(51) Int. Cl. H04B 1/38; H04L 5/16; H04L 12/66; H04L 12/28; H04L 12/56

(52) U.S. Cl. 370/397; 370/352; 375/222

(57) ABSTRACT

The invention specifies a method of allocating resources efficiently for network capacity management of voice traffic in a packet based broadband network. The method includes the specifications of the logical network architecture, its components, the information model associated with the components, and the computation algorithms for network capacity management. The invention is independent of the transport network technologies.

The logical network architecture has a tree topology structure. The method of this invention groups voice traffic flows into aggregate flows segment by segment. Statistical multiplexing techniques such as the Erlang formula can be used to efficiently allocate resources to each aggregate segment. A rule for consistent assignment of the blocking probabilities for the aggregate segments is specified. The method identifies the necessary information that should be defined for each aggregate segment. The method also specifies computation algorithms to compute a number of parameters for each segment, including but not limited to:

equivalent bandwidth required

blocking probability

number of telephones supported

The method also specifies useful reports and alarm indications that can be generated to aid network operators in their network capacity management functions.

A new feature for voice switches, hierarchical call blocking is also specified. With this feature, high concentration can be achieved without the possibility of overloading.

### FIELD OF THE INVENTION

The present invention is directed at capacity management of voice traffic in a packet based broadband access network. The invention specifies a method of allocating network resources efficiently in such a network. The method specifies the logical network architecture, its major components, the information model associated with the components, and the computation algorithms for capacity management. Based on these, useful reports and alerts can be generated to aid network operators in various network capacity management functions.

### BACKGROUND OF THE INVENTION

Network traffic, especially for data applications, is growing at a rapid rate. With this increase in usage, users are demanding more and more bandwidth, especially access bandwidth, as access is usually the bottleneck of the network. In response to this need, a number of access technologies have been developed to provide users with cost effective alternatives to access the network. Examples are cable modems and digital subscriber loop (DSL) modems.

Both cable modem and DSL technologies have been adopted by carriers, especially in the residential and small business market. The initial service offered by the carriers for these access technologies is Internet access. However, both service providers and users realize that huge cost savings can be achieved by putting voice traffic on the same access lines.

Access to Voice Switches

Currently voice services are provided by the traditional TDM based Class 5 switches. The Class 5 switches support a number of access arrangements. The most popular method is to use Telcordia's GR-303 specification. FIG. 1 is an illustration of the concept of the GR-303 specification. In the GR-303 specification, the cooper loops are terminated at remote terminals (RT). These are the usual green boxes at sidewalk curbs or on top of telephone posts. The RTs are connected to the Class 5 switches via T1 circuits. In order to optimize bandwidth on the T1 connections, bandwidth is not allocated until a user picks up the phone. The circuit (also referred to as time slot) allocation is carried out through the use of a signaling protocol, known as the time-slot management control (TMC) protocol.

As time slots are assigned dynamically, it is not necessary to dedicate a time slot to each phone on a permanent basis. Statistic multiplexing is possible and a much smaller number of circuits (or time slots) is required. This reduction in bandwidth usage is commonly referred to as concentration. However, to provide satisfactory quality of service, a sufficient number of available circuits have to be allocated. The most well known method for calculating this concentration ratio is the Erlang formulae. The Erlang formulae express the relationship among the following three variables: (1) the busy hour traffic load, (2) the number of circuits allocated, and (3) the blocking probability. The formulae allow network operators to determine the value of any one of the variables from the other two.

A major shortcoming of the prior art is that the traditional TDM based Class 5 switch manages call blocking only for the interfaces that are directly attached to it. The Class 5 switch assumes that the telephones are connected directly to an RT, which, in turn, is directly connected to the switch. A new generation of voice switches begins to appear in the marketplace. These switches typically accept voice traffic in packet format. As access networks evolve, the logical topology of the network will be more complicated than that associated with TDM based Class 5 switches. This invention addresses this problem by specifying a new network capacity management method.

Emerging Access Technologies

The digital subscriber loop (DSL) technology is widely accepted by the market as a means of providing broadband access. FIG. 2 illustrates a typical arrangement for DSL access. In DSL access, the service provider usually deploys an integrated access device (IAD) 101 at the customer premise. The IAD is connected to the local serving office 103 through a single cooper loop 102. The IAD will provide an Ethernet port for data access 104, and a number of voice jacks (105 & 106) for phones (107 & 108). Both the data traffic and voice traffic are multiplexed on top of the single cooper loop. For DSL, ITU-T and ATM Forum standards specify the use of asynchronous transfer mode (ATM) as the layer 2 multiplexing technology. Data and voice traffic are carried over separate virtual circuits (VC), VC 115 for data and VC 114 for voice traffic respectively. The DSLAM (110), located at local serving office 103, demodulates the analog signal, and then forwards the traffic to an ATM network, represented by the ATM switch 111. The egress ATM switch would then de-multiplex the data and voice traffic and forward them to the appropriate equipment (112 for voice services & 113 for data services). Note that the single ATM switch shown in the figure can be an entire ATM network.

In cable modem, the arrangement is similar, except that the cable is shared by many users, while, in DSL, the access copper loop is dedicated to a single user. The deployment of integrated access is not just limited to the new broadband access technologies. Many users are using this technology with traditional access methods such as T1 and T3 access circuits.

Equivalent Bandwidth

In a traditional TDM network, the resource needed to support a connection is expressed in a single parameter, the bandwidth needed. In a packet network, the traffic usually is characterized by a number of parameters. In the case of ATM, for example, the following parameters are used to describe the traffic of a virtual circuit:

Peak cell rate (PCR)

Sustained cell rate (SCR)

Maximum burst size (MBS)

Cell delay variance tolerance (CDVT)

In order to provide the required quality of service, ATM switches usually keep track of resources allocated to virtual circuits (VC) that run through them. For example, buffers and link capacity have to be allocated to support the requested service for a VC. To simplify connection control, the switch coverts all the traffic parameters of a VC to a single value commonly referred to as equivalent bandwidth in the literature. The equivalent bandwidth represents the amount of link capacity that should be allocated to support this VC. In addition to the traffic parameters, the value of equivalent bandwidth would depend on a number of factors and policies:

The service requests (CBR, VBR-rt, VBR, etc)

The speed of the physical link

The scheduling discipline of the link

The traffic load of the link

Policies of the service providers, etc

In other packet networks such as those that are based on the Internet Protocol (IP), similar parameters are used to describe traffic flows. For example, instead of peak cell rate, peak bit rate is used.

Voice traffic can be encoded in a number of ways, such as Pulse Code Modulation (PCM) as specified in ITU-T G.711, Adaptive Differential Pulse Code Modulation (ADPCM) as specified in ITU-T G.726, and Conjugate Structure-Arithmetic Code Excited Linear Prediction (CS-ACELP), as specified in ITU-T G.729. Furthermore, even with the same coder, the voice traffic can be packetized by different encapsulation schemes. Each encoding method and encapsulation scheme would result in different equivalent bandwidth. For example, using AAL 2 to carry PCM traffic would need approximately 82 Kbps of equivalent bandwidth, while using AALL 2 to carry 32 Kbps ADPCM traffic would need 37 Kbps of equivalent bandwidth.

When compressed voice is used, there is a slight complication with respect to fax calls. In most communications systems, the voice switch and/or the IAD will detect a fax call based on the presence of the 2100 Hz tone in the initial call set up phase of the fax call (ITU-T T.30). The switch and/or the IAD would then up-speed to PCM automatically. Therefore adjustment to account for the fax traffic is needed for capacity management purpose. The network operator could assume that only a certain percentage of the calls are fax calls. As an example, if the network operator sets this percentage to be 10%, the adjusted equivalent bandwidth for the ADPCM case would be 0.1*82+0.9*40 =44.2 Kbps.

### SUMMARY OF INVENTION

This invention describes a method for the capacity management of voice traffic in a packet based broadband access network. Using this method, the user can efficiently allocate network resources while meeting performance objectives. The access network can be based on a number of transport technologies such as ATM, IP, and frame relay.

The method accommodates an architecture where integrated access devices (IAD) are connected to voice switches though dedicated resources. The IADs can be located at the customer premises or in the distribution network. Telephones are connected to these IADs. The voice switch can be traditional Class 5 TDM switches as well as the new generation of packet based switches. Switching of the voice traffic is carried out by the voice switches. This mode of operation applies to voice over DSL, voice over cable modem, and other similar technologies. FIG. 3 shows the basic configuration of such a typical network. For simplicity, only one voice switch is shown in the figure. In practice, the network would have multiple voice switches, each supporting a number of integrated access devices (IAD) and telephones.

The logical network connecting the IADs to the voice switch forms a tree topology. Prior art in capacity management is not adequate to support this type of configuration. Traditional Class 5 switches and even some of the new generation packet based switches support call blocking only for the interfaces that are directly attached to them. These switches are not aware of the logical tree structure of the access network. Using the prior art would require the network operator to allocate full resources to support all the phones without concentration for all segments of the tree, except for the segment that are directly connected to these switches. This results in sub-optimal resource allocation and poor performance.

This invention takes into account that the logical topology of the access network is a tree structure. To ensure good performance, blocking probability of all segments of the tree must be assigned consistently. Such a rule is included in the specification. In computing the number of telephones supported and the associated required equivalent bandwidth of a particular segment, information on other segments is needed. The specification includes an embodiment of the information model for all segments and the computation algorithms to efficiently compute these parameters in the information model. The information model and the computation algorithms can be implemented in network capacity management software tools for managing large networks. Using these software tools, network operators can generate reports to help their network capacity planning and to identify congestion points of the network. Examples of such reports are:

Network resources required link by link for a given network.

Alarm indications where projected traffic load exceeds allocated resources.

Alarm indications when required resources do not adhere to the user's policy, etc.

A new feature for voice switches, hierarchical call blocking is also specified. With this feature, high concentration can be achieved without the possibility of overloading.

### BRIEF DESCRIPTION OF THE DRAWINGS

FIG. 1 is an illustration of the configuration of Telcordia's GR-303 specification.

FIG. 2 is an illustration of the arrangement for DSL access to support both data services and voice services. The voice services can be provided by either the traditional TDM based Class 5 switches through GR-303 gateways, or the new generation of packet based voice switches.

FIG. 3 shows an example of a network where integrated access devices (IAD) are connected to a voice switch through a packet based access network. For simplicity, only a single voice switch is shown in the figure. In practice, many voice switches can be connected to the network.

FIG. 4 shows an example a network using DSL access to a Class 5 switch via a GR-303 gateway.

FIG. 5 shows the tree structure associated with the network in FIG. 4.

FIG. 6 shows the VP assignment of the tree structure in FIG. 5.

FIG. 7 is a table summarizing the characteristics of the VP segments of the tree structure in FIG. 6.

FIG. 8 is a table summarizing the computation for the required equivalent bandwidth associated with each VP segment for the tree structure in FIG. 6.

FIG. 9 is a graphic representation of the results presented in FIG. 8.

FIGS. 10A and 10B show the flowcharts for the computation of the number of telephones supported by all the segments.

FIGS. 11A and 11B show the flowcharts for the computation of the required equivalent bandwidth for all the segments.

FIG. 12 is a table summarizing the computation of the number of required circuits for the segments where the blocking probabilities for all segments, level 2 and above, are 0.

FIG. 13 is a graphic representation of the results in FIG. 12.

FIG. 14 is an illustration of the architecture of DSL access to Class 5 switch using a GR-303 gateway.

FIG. 15 is a table summarizing the computation of the effective bandwidth of segments where phones from an IAD are connected to two different remote terminals (RT).

FIG. 16 is an illustration of the structure for information maintained by a voice switch to support hierarchical call blocking for the tree structure in FIG. 5.

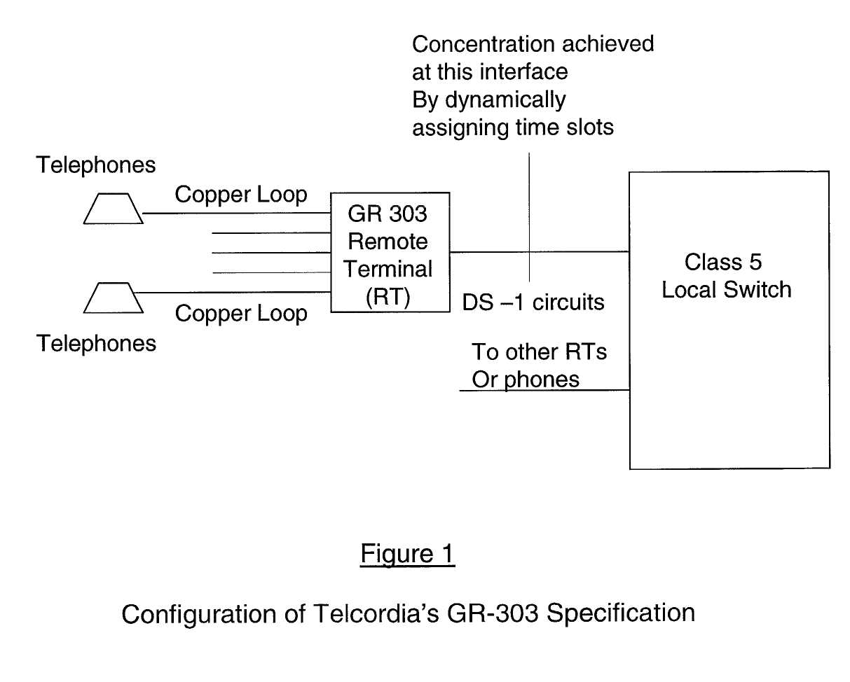

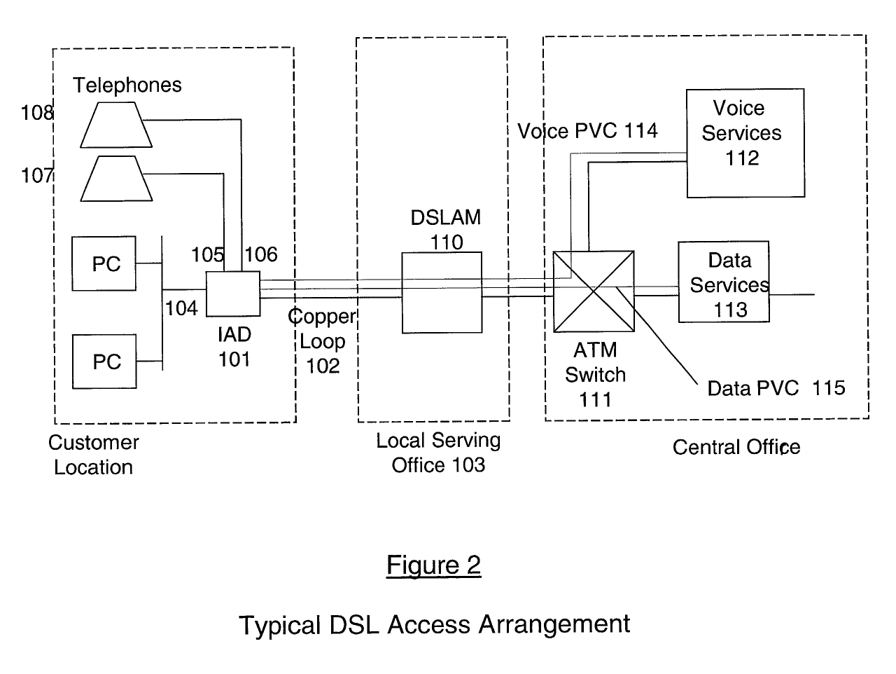

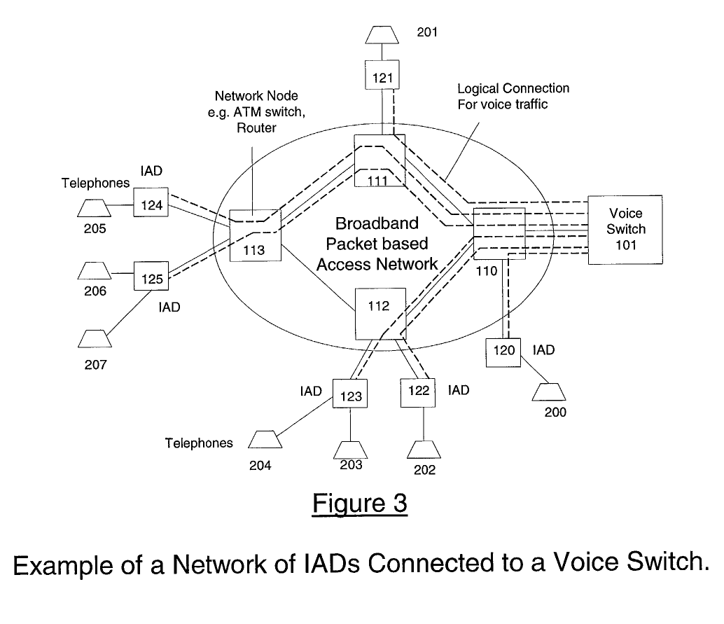

### DETAILED DESCRIPTION OF THE INVENTION

The present invention is first described in the context of supporting packet voice over DSL. In DSL, the ITU-T standards specify ATM as the layer 2 technology. The IADs are first connected to DSLAMs (Digital Subscriber Loop Access Multiplexers), which would demodulate the analog DSL signal from the IAD to ATM cells and then forward them to the appropriate destinations through an ATM network (and vice versa in the opposite direction). In standards such as ATM Forum Specification atmf-0145, “Loop Emulation Service using AAL 2”, the voice traffic is multiplexed onto a single permanent virtual circuit (PVC) to the voice switch using AAL 2 (ATM adaptation Layer). In the initial deployment, the voice switches are the traditional Class 5 switches. GR-303 gateways are used to convert voice packets to TDM format and vice versa.

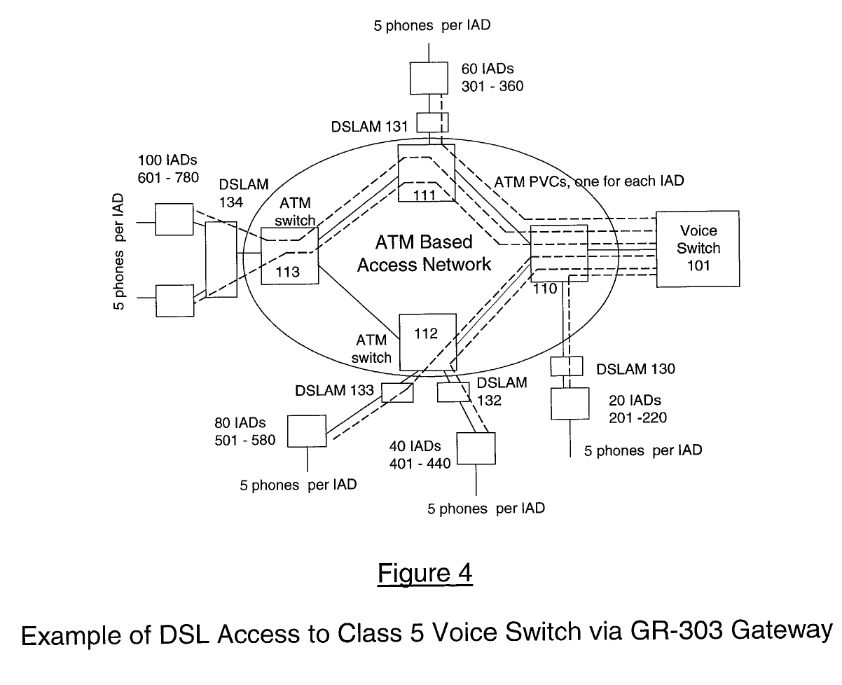

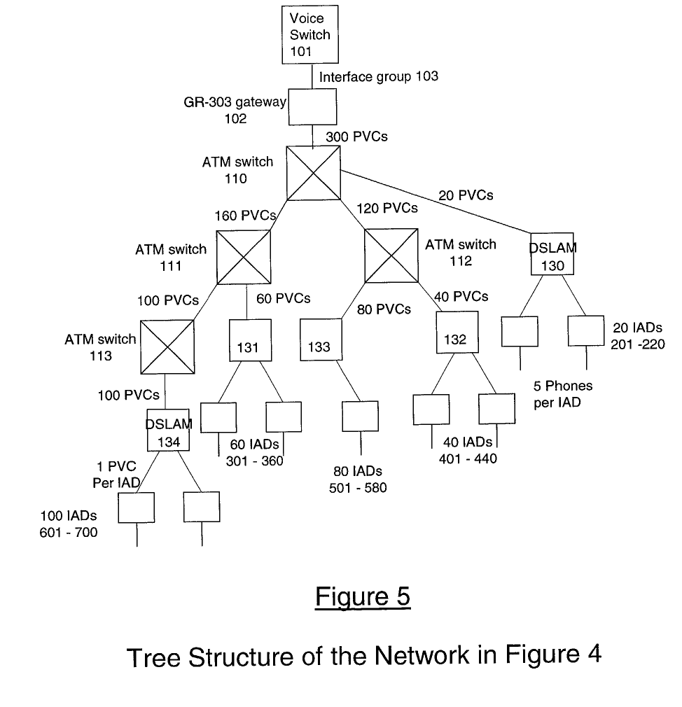

As an illustration, an example of such a network is shown in FIG. 4. In this example, the ATM network consists of 4 ATM switches (110, 111, 112, and 113) in a ring configuration. A Class 5 voice switch 101 is connected to GR-303 gateway 102 through interface group 103. Gateway 102 in turn is connected to ATM switch 110. Connected to ATM switch 110 is DSLAM 130, which in turn is connected to 20 IADs (201 to 220). Connected to ATM switch 111 is DSLAM 131, which is connected to 60 IADs (301 to 360). Connected to ATM switch 112 are two DSLAMs 132 and 133. They are connected to 40 and 80 IADs respectively (401 to 440 and 501 to 580). Connected to ATM switch 113 is DSLAM 134, which is connected to 100 IADs (601-700). Each IAD is assumed to have 5 telephones connected to it. The IADs are connected to the gateway through ATM PVCs, one PVC for each IAD. For IADs connected to DSLAM 130, the PVCs pass through ATM switch 110. For IADs connected to DSLAM 131, the PVCs pass through ATM switch 111 and then ATM switch 110. For IADs connected to DSLAM 132 and 133, the PVC pass through ATM switch 112 and then 110. For IAD connected to DSLAM 134, the PVCs pass through ATM switch 113, 111, and then 110. As there is only one single GR-303 interface group between the gateway and the Class 5 switch, an implicit assumption is that all the telephones are connected to one remote terminal module in the gateway, as each remote terminal module would have its own GR-303 interface group.

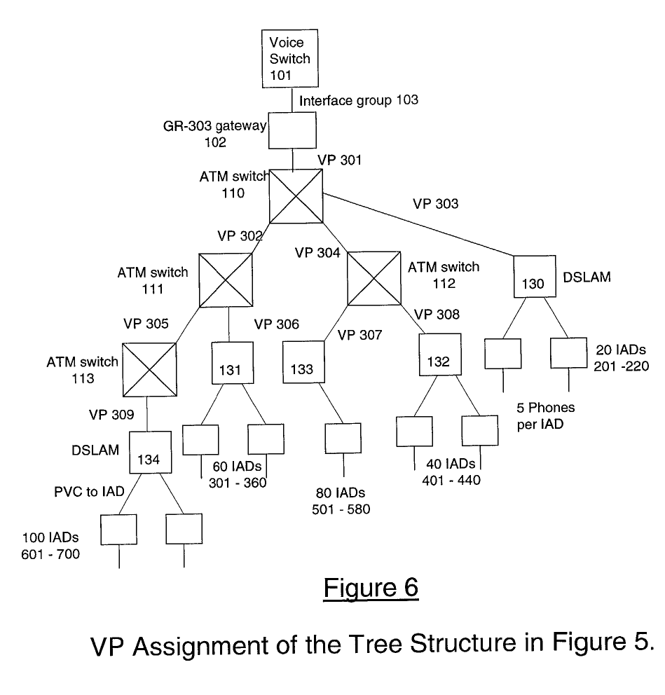

The topology of the above network logically forms a tree. Furthermore, there are multiple PVCs between the DLASM and ATM switches, among the ATM switches, as well as between the ATM switches and the gateway. The logical tree topology is shown in FIG. 5.

Using prior art to engineer this network, the process would first use the Erlang formula or similar means to determine the number of circuits required for the GR-303 interface group 103. Let us assume that each phone generates 15 minutes of traffic during the busy hour. The total traffic load of the network is 1500*15/60=375 erlangs. For a blocking probability of 1%, 400 circuits (or time slots) would be required. However, for the PVC connections between the gateways and IADs, resources are fully allocated to support each phone. In this example, as there are 5 phones connected to each IAD, the network operator would allocate resources to support 5 simultaneous calls for each PVC. Since it is unlikely that all the phones would be active at the same time, allocating dedicated resources to each phone is wasteful and thus a better method is needed.

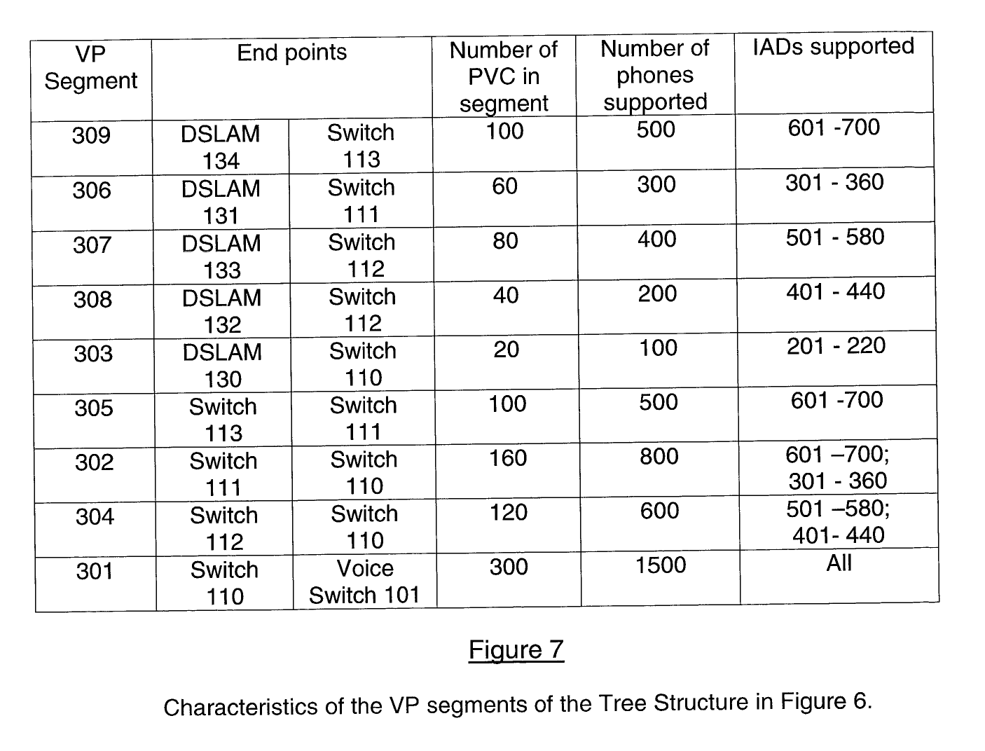

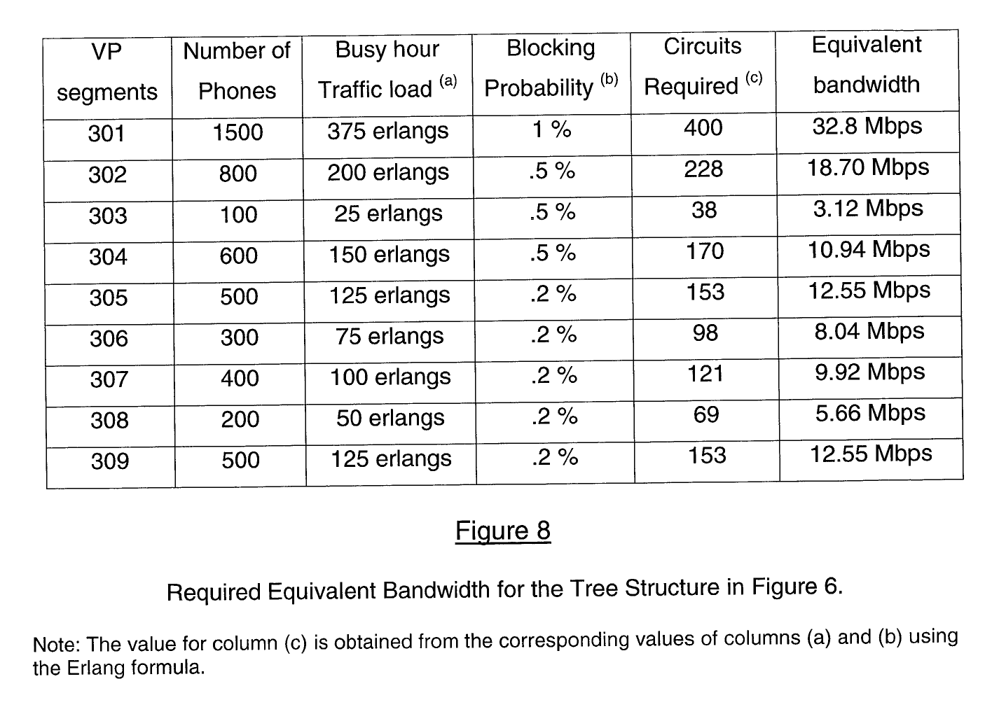

In the present invention, PVC segments over the same physical link are consolidated into virtual path (VP) segments. Resource will be allocated to individual VP segment as an aggregate as opposed to individual PVCs. Statistic multiplexing techniques can be used to efficiently allocate resources to these segments. The ATM switches are configured to manage the traffic of these segments at the VP level as opposed to at the VC level. A diagram showing the VP segments within the tree network is shown in FIG. 6. A table summarizing the characteristics of the VP segments is shown in FIG. 7.

The following terminology would be used to describe the relationship among the VP segments. When two or more VP segments are merged to an upstream VP segment (e.g. VP 305 and VP 306 merged into the VP 302), the upstream VP (VP 302 in this case) is referred to as the parent VP. The downstream VP segments are referred to as child VPs. The term “level” would be used to describe the distance of the VP segments in terms of number of hops from the voice switch. For this example, we have the following:

The level 1 segment consists of VP 301.

The level 2 segments consist of VP 302, 303, and 304.

The level 3 segments consist of VP 305, 306, 307, and 308.

The level 4 segment consists of VP 309.

There can only be a single level 1 segment in a tree (VP 301 in this case), and it is referred to as the root segment.

Since GR-303 interface group 103 has 400 circuits allocated to it, the Class 5 switch would not allow more that 400 calls on this tree network. Therefore each VP segment would only require resources to support at most 400 calls. Higher concentration can be achieved if each VP segment is engineered using the Erlang formula or similar means. As the Class 5 switch only blocks calls at the GR-303 interface group 103, and not at the segment level, it may allow more calls to go through a VP segment than the allocated resources. Take VP 305, for example. There are 100 PVCs within this VP and so this VP supports 500 phones. The traffic load is 125 erlangs. For a blocking probability of 1%, resources equivalent to 144 circuits would be allocated. However, the Class 5 switch, unaware of the tree structure, could allow more than 144 calls go through this VP segment. In this situation, the VP segment is overloaded.

The only exception to the above situation is the level 1 VP (VP 301 in this example). If all the telephones of a tree network are connected to a single remote terminal as in the case in this example, the resource allocated to the Level 1 VP should be equivalent to the size of GR-303 interface group.

Whether to allow for overloading is a network policy of the service provider. Service providers can always prevent overloading by setting all the blocking probability for all VP segments, level 2 and above, to be 0. The blocking probability of the level 1 VP segment should be the same as that of the GR-303 interface group. Other service providers may accept overloading with a small probability as the cost savings can be significant. The present invention supports both cases without modification.

As the VP segments form a tree structure and are not independent from each other, the blocking probabilities of the segments have to be assigned consistently, according to the following rule:

The blocking probability of the child VPs should be less than or equal to the blocking probability of the parent VP segment.

For example, let the blocking probability of VP 301 to 309 be α₀, α₁, α₂, α₃, α₁₁, α₁₂, α₂₁, α₂₂, α₁₁₁ respectively. This rule would implies:

α₀ (the blocking probability for VP 301) ≧α₁, α₂, and α₃ (the blocking probability for VP 302, 304, and 303, all its children)

Similarly,

α₁≧α₁₁ and α₁₂

α₂≧α₂₁ and α₂₂

α₁₁ ≧α₁₁₁

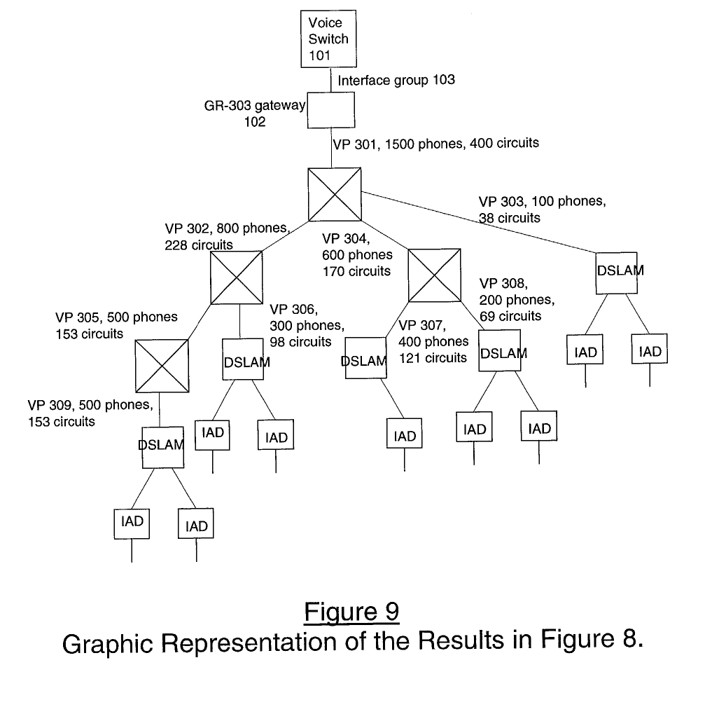

As a numerical example for the case that allows for overloading, let each telephone generates 15 minutes of traffic during the busy hour. Let the blocking probability of VP 301 be 1%, the blocking probability of the level 2 VP segments (302, 303, and 304) be 0.5%, and the blocking of the rest VP segments be 0.2%. For PCM voice over AAL 2, the equivalent bandwidth of a call is about 82 Kbps. With these assumptions, the two parameters (1) the number of circuits required, and (2) the effective bandwidth required, can be computed using the Erlang formula for all segments. The results are summarized in a table in FIG. 8. The effect of concentration and savings in network resources are evident from the table. The concentration ratios for VP 301 to 309 are 3.75, 3.51, 2.64, 3.53, 3.27, 3.06, 3.31, 2.90 and 3.27 respectively. The results are also presented in a graphic format in FIG. 9.

Information Model and Computation Algorithms

For large networks, the computation described above is quite tedious. An embodiment of the information model and the computation algorithms are described below. They can be implemented in software tools, enabling fast and easy computation.

The most important components of the network architecture are the VP segments. For each VP segment, the following information should be defined and stored:

a) ID of the VP segment

b) ID of parent VP segment

c) Downstream node type: Each VP segment is a connection between two nodes. The downstream node is the one further away from the voice switch. There are two possible types of nodes: end node or intermediate node. In a DSL access network, the DSLAMs would be end nodes while the ATM switches are intermediate nodes.

d) List of child VP segments: End nodes would have no child VP segments.

e) Number of telephones that are attached directly to a VP segment's downstream node

f) Number of telephones supported through this VP segment:

The value of this parameter would be computed from other parameters including the same information from the child VP segments.

The algorithms will be described later.

g) Traffic profile of the telephones

h) Encoder and encapsulation scheme used

i) Required number of circuits for this VP segment

j) Required equivalent bandwidth for this VP segment

The value of this parameter would be computed from other parameters including the same information from the parent segment.

The algorithms will be described later.

k) Current assigned equivalent bandwidth for this VP segment

l) Desired blocking probability over this VP segment

m) The physical links over which the VP segment transverses.

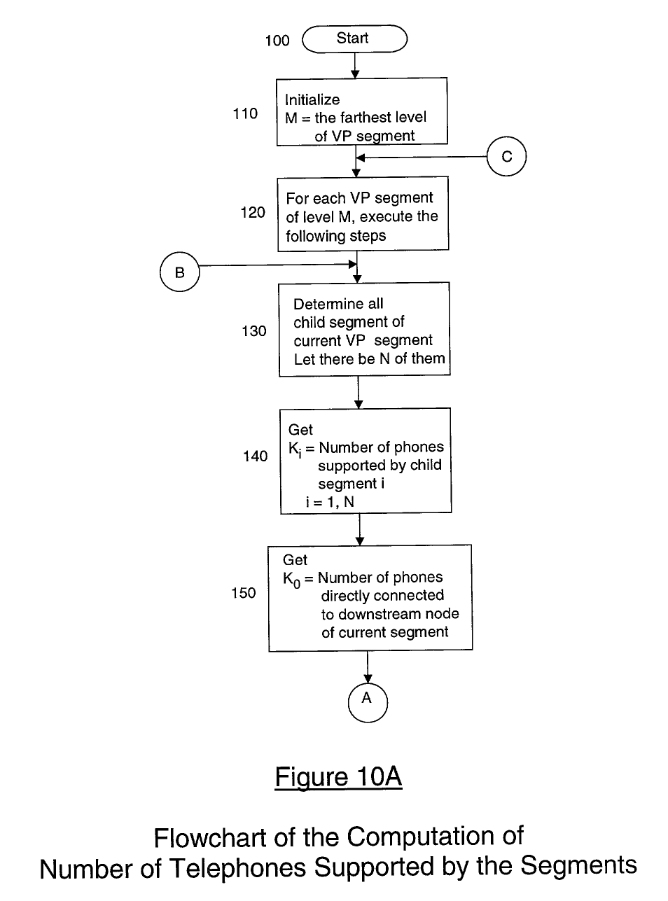

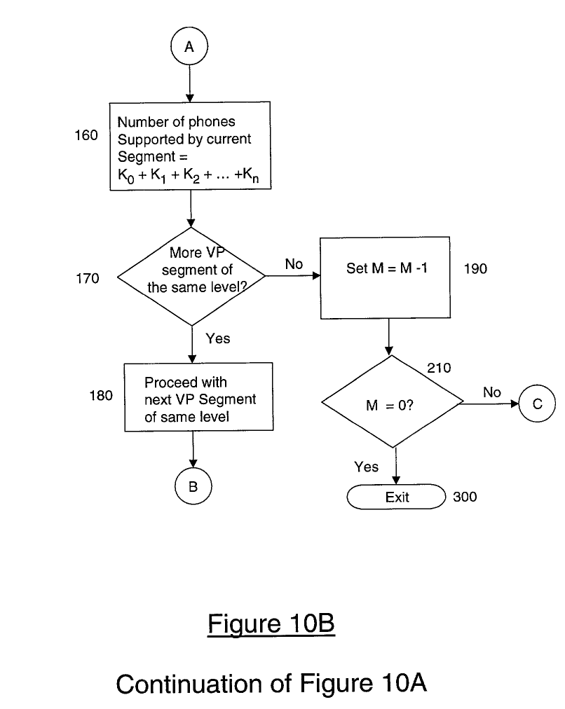

Parameters (f) and (i) are computed from the other parameters. An embodiment of the computation algorithm, consisting of two stages, is described as follows. In the first stage, the system determines the number of telephones that is supported (parameter f) segment by segment. For each segment, this value would be equal to the sum of (1) the number of telephones directly attached to the downstream node, and (2) the number of telephones that are supported by all its child segments. The algorithm computes this value beginning with VP segments with the highest level (i.e., farthest from the voice switch) and proceeds towards the root of the tree. A flowchart implementing the above logic is shown in FIGS. 10A and 10B. Details of the steps are described below. The steps follow each other in sequence unless otherwise stated:

Step 100: Start of the computation process

Step 110: Initialize the value of parameter M to be the highest level of the VP segment (i.e., the computation begins with the highest level of the tree)

Step 120: For each VP segment of level M, execute step 130 to 210

Step 130: Determine all the child segments of the current VP segment. Let there be N of them.

Step 140: Get the value of the number of phones supported by each child segment, (parameter f of the child segment). This value is available as the computation begins with the highest level and proceeds towards the root. Therefore, this value is already computed. Let these values be Ki, i=1, N.

Step 150: Get of the value of the number of phones directly connected to the downstream node of the current segment (parameter e). Let this value be K0

Step 160: Set K, the number of phones supported by the current segment, equals the sum K0 and all the Ki. (i.e., K=K0+K1+K2+k3+. . . Kn)

Step 170: Check whether there are more VP segments of the same level to be processed. If yes go to step 180, otherwise go to step 190.

Step 180: Proceed with the next VP segment of the same level and go to step 130.

Step 190: The parameter M is updated to M−1.

Step 200: Compare M with 0. If M>0, proceed with the next lower level by going to step 120. If M=0, this means all levels have been processed and the algorithm terminates.

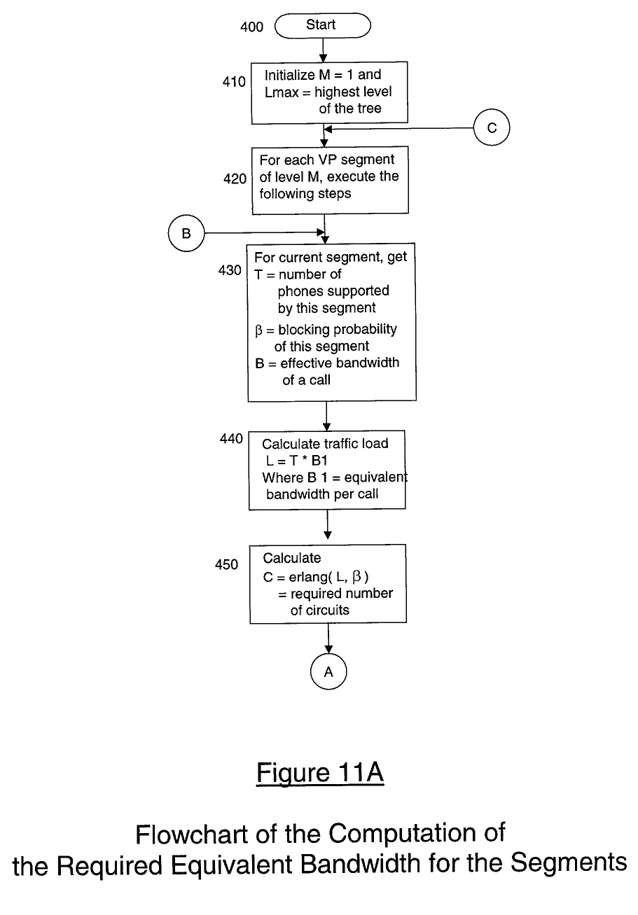

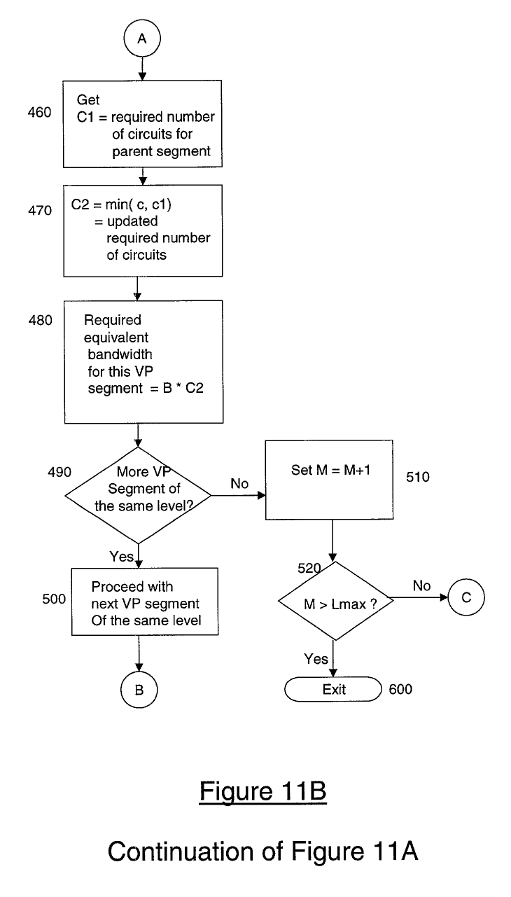

In the second stage, the algorithm then computes the equivalent bandwidth for the VP segments. This stage involves a number of computations. The key point is that this computation should start from the root and proceed down the tree, level by level. A flowchart implementing the logic is shown in FIGS. 11A and 11B. The details of the steps are described below. The steps follow each other in sequence unless otherwise stated:

Step 400: Start of the computation process.

Start 410: Initialize M to be 1. This parameter represents the value of the current segment level and so the algorithm begins at the root. Let Lmax be the value of the highest level of the tree.

Step 420: For each VP segment of level M, execute steps 430 to 490.

Step 430: For the current VP segment, get the following values:

T=The Number of phones supported by this segment. This is parameter f of the VP segment, which has been computed in the first stage.

β=The blocking probability of this segment (parameter k)

B=The effective bandwidth of a single call (This is determined by parameter h, the encoder and encapsulation scheme used)

Step 440: Determine B1, the equivalent bandwidth per call, from the traffic profile (parameter g). The traffic load L would be equal to =T*B1.

Step 450: Use the Erlang formula to compute number of required circuits C from the load L and the blocking β.

Step 460: Get the value of the number of the required circuits for the parent segment, C1. This value is available as the algorithm starts from the root and proceeds download level by level.

Step 470: Let C2 be the minimum of C and C1. This would be the updated value for the required number of circuits of this VP segment.

Step 480: The required equivalent bandwidth of this segment, parameter (i), is the product of C2 and B.

Step 490: Check whether there are more VP segments of the same level to be processed. If yes go to step 500, otherwise go to step 510.

Step 500: Proceed with the next VP segment of the same level and go to step 430.

Step 510: The parameter M is updated to M+1.

Step 520: Compare M with Lmax, the highest level of the tree. If M≦Lmax, proceed by going to step 420. If M>Lmax, this means all levels has been processed and the algorithm terminates.

The above described algorithm calculates the number of required circuits C from the traffic load L and blocking probability β. Other variations are possible. For example, calculate β from L and C or calculate L from β and C.

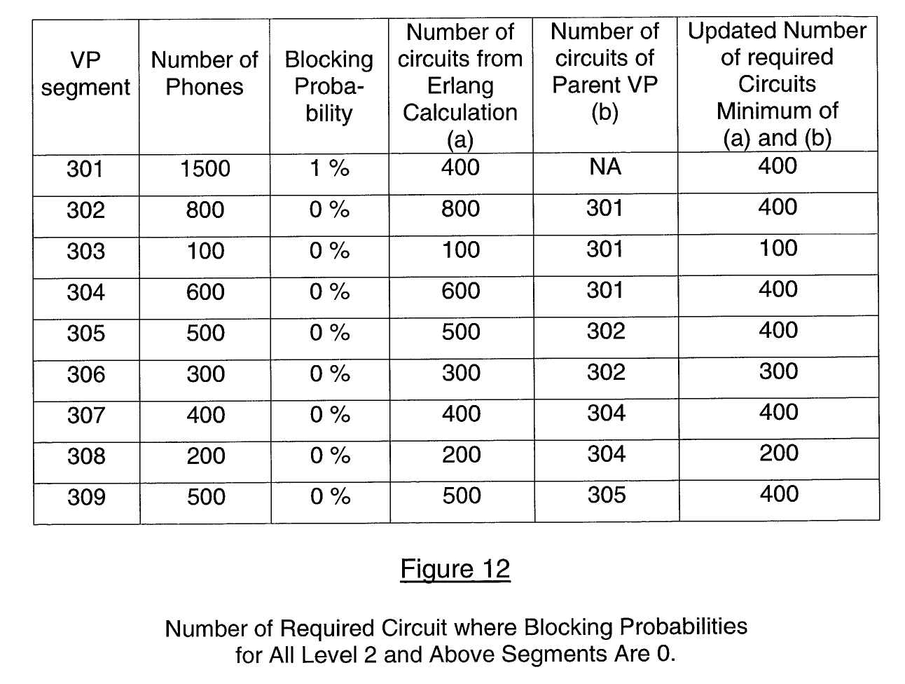

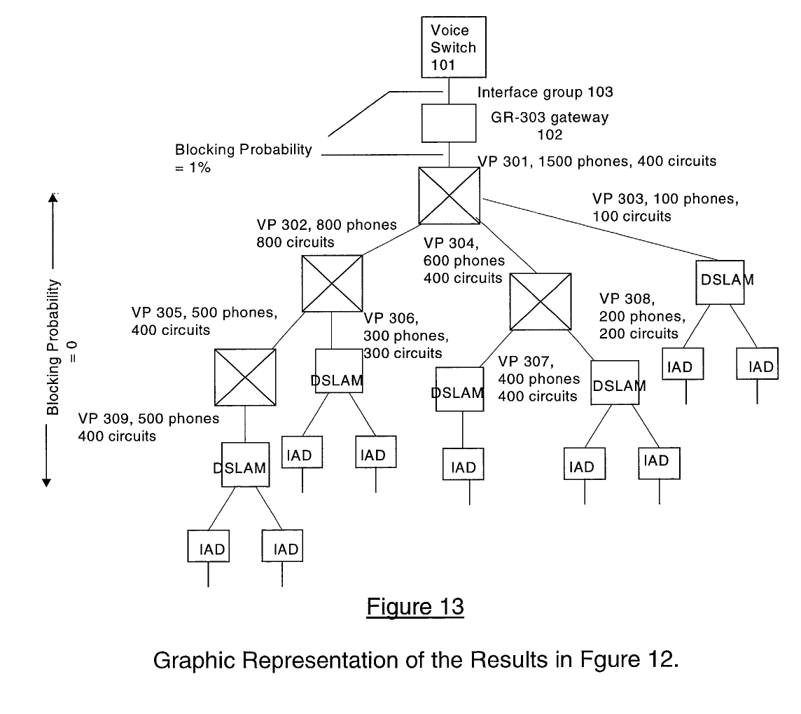

As remarked earlier, some service providers may not allow for overloading. The method supports this case by setting the blocking probabilities of all VP segments of level 2 and above to be 0. Using the same network as an example, the results are summarized in a table in FIG. 12. FIG. 13 is a graphic illustration of the above results. One can observe that, even in this case, concentration is possible for some VP segments. The concentration ratios for VP 301 to VP 309 are 3.75, 3.75, 1, 1.5, 1.25, 1, 1, 1, and 1.25 respectively. Comparing the results here with the case that allows for overloading, it is clear that substantial network resource savings can be realized by allowing for overloading.

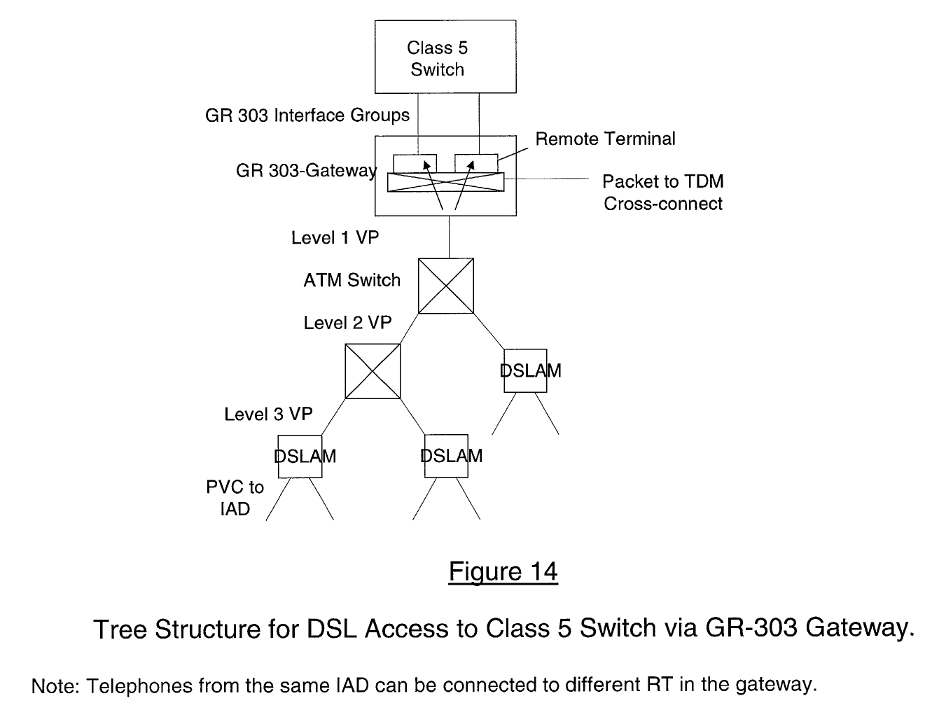

In our example, all the telephones are connected to the same RT module in the gateway. In GR-303, each RT can only support up to 2048 phones. As the network grows, it is possible that telephones from the same IAD would be cross-connected to different RTs. FIG. 14 is an illustration of the DSL access to GR-303 gateway showing this possibility. This scenario can be supported in the following manner:

1. First segregate all the telephones of the tree network into groups. Each group comprises telephones connected to the same RT. The groups share the same tree-network topology.

2. Apply the method to each group separately. The policies governing each group such as blocking probabilities could be different.

3. The required equivalent bandwidth of the aggregate VP segments would be the sum of the corresponding segments from each group.

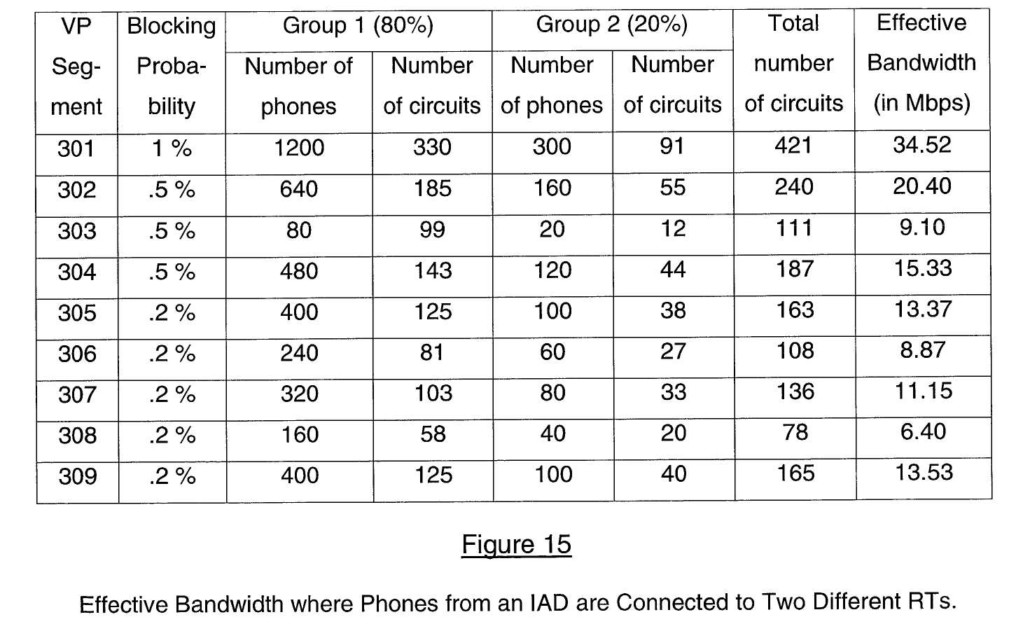

Using the same example, let us assume that the tree is connected to two RTs. Eighty percent of the telephones are connected to RT1 while the rest to RT2. The effective bandwidth for each segment can be computed using the present method and the results are summarized in a table in FIG. 15.

New Generation of Packet Based Voice Switches

The method is applicable without modification when the voice switch is one of the new generation packet based voice switches. As a matter of fact, these new voice switches could provide a new feature by maintaining the following information in its database:

The parent-child relationship of the VP segments

The resources allocated to each segment

The telephone numbers supported by each VP segment

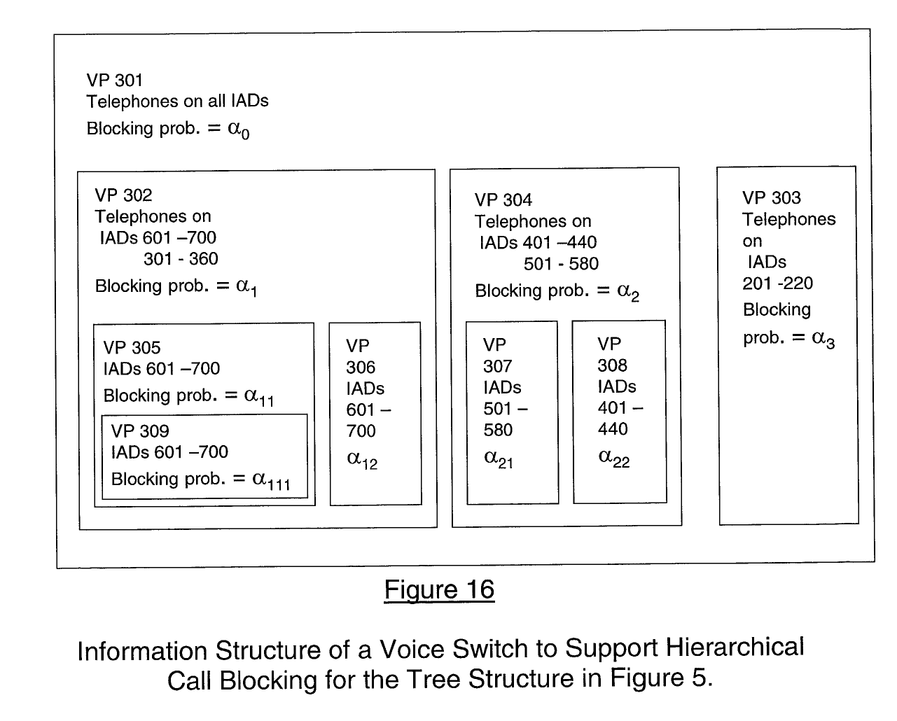

Based on this information and the current traffic load of the VP segments, the voice switch would decide whether to block a call or not. With this new feature, overloading would never occur on any VP segment even the call blocking probability is not0. Therefore this hierarchical call blocking capability is a highly desirable feature in terms of network capacity planning. FIG. 16 is an illustration of the structure of the information maintained.

Physical Link Limitation Considerations

The VP segments are carried over physical links. Each physical link can support a number of VP segments. As long delay adversely affects the quality of a call, voice traffic is typically assigned a high priority in the ATM network (e.g. CBR service or VBRrt service). However, if too much high priority traffic is allocated to a physical link, it can cause large delay variation between packets of a call. This results in large de-jitter buffer in the voice switches and the IADs, which introduces more delay and causes higher packet loss rate. Therefore, most network operators would only assign up to a pre-specified percentage of a link for high priority traffic to ensure good performance. The usual policy is 30-50%. In generating reports, an alarm indication will be displayed to the network operator if the total equivalent bandwidth for voice traffic exceeds the pre-specified allowable bandwidth for high priority traffic.

Usage

The method described above can be used to produce a number of useful reports. The following are some examples:

1. The network operator inputs to the software tool, for each tree subtending from the voice switches:

The topology of the VP network

The number of telephones connected to the network node

The traffic profile of a telephone

The equivalent bandwidth needed to support a call

The desired blocking probability of the VP segments The system would provide, as an output, the equivalent bandwidth for each VP segment. One use of this output is to support network capacity planning.

2. The network operator inputs to the software tool the above information as described in item 1 and the equivalent bandwidth currently assigned to each VP segments. The system would provide, in addition, instances where the required bandwidth exceeds or is within a threshold of the allocated bandwidth. One use of this output is to support network capacity maintenance.

3. The network operator inputs information as described in item 1. The software tool would output the actual blocking probability based on the allocated equivalent bandwidth. One use of this output is to support network capacity maintenance.

4. The network operator inputs information as described in item 2. The software tool would output reports to indicate instances where the total required equivalent bandwidth of all the VPs over a physical link exceeds a certain threshold. One use for this report is to identify the congestion points of the physical network.

5. The network operator inputs the above information in item 1, except that the network operator would input the allocated effective bandwidth of the segment instead of the number of the telephones. The number of telephones that can be supported would be the output instead.

The above examples of outputs can be generated to support network capacity management. Those skilled in the art can readily identify other related usages. The method is flexible so that the user can analyze many “what if” scenarios in network capacity management.

Supporting Other Access Technologies

The central theme of the present invention is to group individual voice traffic flows into aggregate flows link by link. Statistical multiplexing techniques can be applied to manage these aggregate flows so that network resources can be assigned optimally. In ATM, VPs are a readily available means of aggregation. However, the concept of VP is not essential for this method. Therefore this invention can be readily applied to other access technologies as long as the aggregate flows can be managed.

In frame relay, the concept of virtual path (VP) does not exist. However, all frame relay switches support the concept of overbooking. In overbooking, resource allocated to a permanent virtual circuit (PVC) is discounted by a factor. The discount factor is an input by the network operator based on their knowledge of the type of applications why the traffic can be discounted. In this invention, the discount factor of a PVC would be different segment by segment as it transverses across the network, and is equal to the concentration ratio of that segment. In our example, segment 304 supports 600 phones and requires 170 circuits. The overbooking factor would be 600/170 or 3.53. The voice traffic, of course, would be high priority traffic. This overbooking technique can also be used in ATM without the use of the concept of VP segments.

The method also applies to an IP based network with minor modifications. The salient points are:

The ATM switches are replaced by routers.

Voice traffic is assigned high priority. One mechanism to do this is specified in the Differentiated Service (diffServ) specifications from the Internet Engineering Task Force (IETF).

Instead of provisioning the VP segment through network management, the topology of the tree network is determined by the routing table in the routers automatically. Specifying the route manually is also possible.

IP has no concept of connections and VPs. However, if a VP segment is interpreted as an aggregate of voice traffic flows as described earlier, the method can be applied to calculate the equivalent bandwidth of the aggregates.

Note that, as before, a single physical link may carry traffic from multiple aggregates. The network operator should avoid putting too much high priority traffic on any physical link. Using this method, reports can be generated to show instances where high priority traffic exceeds a pre-specified threshold.

MPLS (multi-protocol label switching) has gathered a lot of attention in the market place. In a MPLS network, the network operator can define label switched path (LSP) between end-points. A LSP supports a hierarchy of labels and they are similar to the VCs and VPs in ATM, except that it is unidirectional. The method applies without major modification to this case. The only difference is that two LSPs are needed to replace a VP segment, as the LSPs are unidirectional.

The above examples demonstrate the diverse applicability of the invention. In summary, it supports:

A large variety of access network topology (ATM, frame relay, IP, MPLS, etc.)

Different types of voice switches, packets based as well as traditional TDM based Class 5 switches

Different encoding and encapsulation schemes by keeping track of the number of telephones supported for each scheme.

Many forms of input and output of the software tool so that the network operator can analyze a multitude of “what-if” scenarios

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method of allocating resources for network capacity management of voice traffic in a packet based broadband network comprising:
a network architecture that decomposes the network into logical components;
an information model that contains the necessary information that must be defined for each type of the said logical components; and
the computation algorithms to determine the optimal network resources to be assigned to each said logical component;
whereas the said packet based broadband network comprising:
a plurality of packet based switching devices;
a plurality of voices switches;
a plurality of integrated access devices; and
a plurality of telephones;
whereas the types of the said voice switches comprising;
packet based voice switches that support hierarchical call blocking;
packet based voice switches that support a single level of call blocking; and
class 5 switches through the use of voice gateways.

2. The network architecture of claim 1 forming a tree structure comprising a plurality of trees subtending from each voice switch, wherein each node of the said trees represents a packet based switching device of claim 1.

3. An embodiment of the method of claim 1 for a broadband packet based network of claim 1 that is based on the asynchronous transfer mode technology, wherein permanent virtual circuits to a voice switch of claim 1 are aggregated into virtual path segments so that statistical multiplexing calculation methods can be applied to the individual said virtual path segments to allocate resources optimally.

4. A method of assigning blocking probabilities among the virtual path segments of claim 3 consistently in that the blocking probability of any said virtual path segment is equal to or less than the blocking probability of its parent virtual path segment.

5. A specification of the information that needs to be defined for each virtual path segment of claim 3 comprising:
identity of the said virtual path segment;
identity of the parent virtual path segment of the said virtual path segment;
type of the downstream node of the said virtual path segment;
list of the child virtual path segments of the said virtual path segment;
number of telephones that are attached directly to the said downstream node;
number of telephones supported by the said virtual path segment;
traffic profile of the said telephones supported by the said virtual path segment;
encoder and encapsulation scheme used;
required number of circuits associated with the said virtual path segment;
required equivalent bandwidth associated with the said virtual path segment;
currently assigned equivalent bandwidth associated with the said virtual path segment;
desired blocking probability of the said virtual path segment; and
identity of the physical link over which the said virtual path segment transverses.

6. An algorithm to compute the number of phones supported by the virtual path segment, which proceeds level by level and segment by segment from the highest level of the tree of claim 2 towards its root by adding the number of telephones that are attached directly to the downstream node and the number of phones supported by all its child virtual path segments.

7. An algorithm to compute the required equivalent bandwidth associated with the virtual path segment, which proceeds level by level and segment by segment from the root of the tree of claim 2 towards the highest level of the said tree, and comprises the following steps:
obtaining the required number of circuits associated with the virtual path segment, using the erlang formula or other means;
comparing the value of the said required number of circuits associated with the virtual path segment from the immediate above step with the value of the required number of circuits associated with its parent virtual path segment;
accepting the minimum of the two said values as the updated value for the required number of circuits associated with the virtual path segment; and
multiplying the said updated value of the required number of circuits associated with the virtual path segment by the equivalent bandwidth of a single call.

8. A variation of the algorithm of claim 7, that computes the blocking probability associated with the virtual path segments, instead of the required equivalent bandwidth associated with the said virtual path segment.

9. A variation of the algorithm of claim 7, that computes the number of telephones supported by the virtual path segments, instead of the required equivalent bandwidth associated with the said virtual path segment.

10. An output of the method of claim 1 showing the required equivalent bandwidth for each virtual path segment.

11. An output of the method of claim 1 showing the call blocking probability associated with each virtual path segment.

12. An output of the method of claim 1 showing the number of telephones supported by each virtual path segment.

13. An output of the method of claim 1 showing instances where the required equivalent bandwidth associated with virtual path segments within a threshold of the allocated bandwidth.

14. An output of the method of claim 1 showing instances where the total of the required equivalent bandwidth associated with all virtual path segments over a physical link exceeds a specified threshold.

15. An embodiment of the method of claim 1 for a broadband packet based network of claim 1 that is based on the frame relay technology through the use of overbooking capability of the frame relay switch.

16. An embodiment of the method of claim 1 for a broadband packet based network of claim 1 that is based on the internet protocol technology through the use of the differentiated service capability of the routers.

17. An embodiment of the method of claim 1 for a broadband packet based network of claim 1 that is based on the multi protocol label switching technology through the use of label switched paths.

18. A method of providing hierarchical call blocking feature in voice switches by maintaining in the said voice switches information comprising:
parent-child relationship of the aggregate segments;
resources allocated to aggregate segments; and
telephone numbers associated with each aggregate segment;
whereas the decision for blocking individual calls is based on the above said information and the current traffic load of the aggregate segments.
